(19) United States
(12) Patent Application Publication
(10) Pub. No.: US 2026/0266339 A1
(43) Pub. Date: Sep. 10, 2026

(54) Bearing Unit and Roller Assembly Including the Same

(71) Applicant: LG Energy Solution, Ltd., Seoul (KR)

(72) Inventors: Dong Hun Lim, Daejeon (KR); Koo Youn Hwang, Daejeon (KR); Min Su Kim, Daejeon (KR)

(73) Assignee: LG Energy Solution, Ltd., Seoul (KR)

(21) Appl. No.: 19/556,391

(22) Filed: Mar. 4, 2026

(30) Foreign Application Priority Data
Mar. 5, 2025 (KR) 10-2025-0028340

(51) Int. Cl. F16C 35/07; F16C 19/26

(52) U.S. Cl. CPC F16C 35/07; F16C 19/26; F16C 2322/12

(57) ABSTRACT

The present disclosure relates to a bearing unit and a roller assembly including the same, and more particularly, to a bearing unit configured to adjust an axial clearance between an inner race and an outer race of a bearing portion supporting a rotation shaft of a roller to an appropriate state, and a roller assembly including the bearing unit.

### CROSS-REFERENCE TO RELATED APPLICATIONS

This application is based on and claims priority from Korean Patent Application No. 10-2025-0028340 filed on Mar. 5, 2025, with the Korean Intellectual Property Office, the disclosure of which is incorporated herein in its entirety by reference.

### TECHNICAL FIELD

The present disclosure relates to a bearing unit and a roller assembly including the same.

### BACKGROUND

Secondary batteries have been applied in small-scale fields such as mobile devices and notebook computers, but recently, the research direction has been expanding to medium and large-scale fields. Secondary batteries are now widely used in the fields requiring high voltage and large capacity in association with, for example, energy storage systems (ESSs) or electric vehicles (EVs). Battery packs may be formed by packaging battery cells formed of these secondary batteries.

In a manufacturing process of the secondary batteries, a roller assembly including a roller configured to roll or convey a specific sheet, a shaft extending from the roller, and a bearing portion supporting the shaft may be used. For example, when manufacturing a dry electrode, powder introduced between a pair of roller assemblies may be press-molded by the rollers to manufacture a sheet-type electrode. Alternatively, a sheet-type electrode introduced between a pair of roller assemblies may be conveyed in a rotation direction of the rollers.

### SUMMARY

The present disclosure provides a bearing unit capable of adjusting an axial clearance between an inner race and an outer race of a bearing portion supporting a rotation shaft of a roller to an appropriate state, and a roller assembly including the bearing unit.

In addition, the present disclosure provides a bearing unit capable of improving durability and/or lifespan of a bearing portion supporting a roller, and a roller assembly including the bearing unit.

The present disclosure is not limited to the aspects described above, and other aspects not described above may be clearly understood by those ordinarily skilled in the art to which the present disclosure pertains from the following description.

A bearing unit according to the present disclosure includes a bearing portion configured to rotatably support a shaft and a piston unit configured to apply an external force to the bearing portion in an axial direction of the shaft. The bearing portion includes an inner race coupled to the shaft and configured to rotate together with the shaft, and an outer race surrounding the inner race such that the inner race is disposed therein. The piston unit includes a first piston disposed on one side of the bearing portion and a second piston disposed on the other side of the bearing portion. When the inner race of the bearing portion moves in a direction in which the inner race deviates from an inner portion of the outer race of the bearing portion and an axial clearance is generated between the inner race and the outer race of the bearing portion, the first piston is configured to push and move the outer race of the bearing portion so as to eliminate the axial clearance, and when the axial clearance is eliminated by the first piston, the second piston is configured to push and move the outer race of the bearing portion such that the inner race deviates from the inner portion of the outer race of the bearing portion. The direction in which the first piston pushes the outer race of the bearing portion and the direction in which the second piston pushes the outer race of the bearing portion may be opposite to each other.

When the shaft undergoes a thermal expansion, the inner race of the bearing portion may move in the axial direction of the shaft.

The bearing unit according to the present disclosure may further include a controller configured to control driving of the piston unit, and the bearing portion includes a rolling member disposed between the inner race and the outer race of the bearing portion and configured to rotatably support the inner race of the bearing portion relative to the outer race of the bearing portion. When the inner race of the bearing portion and the outer race of the bearing portion contact the rolling member, the controller may determine that the axial clearance has been eliminated.

The bearing unit according to the present disclosure may further include a controller configured to control driving of the piston unit and a temperature sensor configured to measure the temperature of the shaft. When the temperature of the shaft is equal to or higher than a predetermined temperature, the controller may determine that the inner race has moved in a direction in which the inner race deviates from the inner portion the outer race of the bearing portion and may drive the first piston to push the outer race of the bearing portion.

The bearing unit according to the present disclosure may further include a controller configured to control driving of the piston unit and a temperature sensor configured to measure temperatures of different regions of the shaft. When a plurality of temperature values measured by the temperature sensor are within a predetermined temperature range, the controller may determine that the inner race of the bearing portion has moved in a direction in which the inner race deviates from the inner portion of the outer race of the bearing portion, and may drive the first piston to push the outer race of the bearing portion.

The bearing unit according to the present disclosure may further include a controller configured to control driving of the piston unit, and a pressure sensor disposed on the first piston and configured to measure a pressure applied to the first piston. When the pressure applied to the first piston is equal to or higher than a predetermined pressure, the controller may determine that an axial clearance between the inner race of the bearing portion and the outer race of the bearing portion has been eliminated, and drive the second piston to push the outer race of the bearing portion.

The first piston may move the outer race of the bearing portion by a first distance, the second piston may move the outer race of the bearing portion by a second distance, and the second distance may be smaller than the first distance.

The bearing unit according to the present disclosure may further include a controller configured to control driving of the piston unit and a distance sensor configured to detect the second distance by which the outer race has moved, and the controller may drive the second piston to push the outer race of the bearing portion until the second distance reaches a predetermined distance.

The bearing unit according to the present disclosure may further include a bearing portion housing configured to accommodate the bearing portion therein, and an outer circumferential surface of the outer race of the bearing portion may be interference-fitted into an inner circumferential surface of the bearing housing.

The external force applied to the bearing portion by the piston unit may be greater than a frictional force between the outer race of the bearing portion and the bearing housing.

The piston unit may move while being guided by the bearing housing.

The piston unit may have an annular shape through which the shaft passes.

At least one of the first piston and the second piston may include a piston member configured to reciprocate along an axial direction of the shaft, and an adapter disposed at an end portion of the piston member facing the outer race of the bearing portion and configured to move together with the piston member. When the piston member moves in a direction toward the outer race of the bearing portion, the adapter may apply an external force to the outer race of the bearing portion.

The adapter may include a first adapter portion configured to contact the outer race of the bearing portion and support the outer race of the bearing portion, and a second adapter portion extending from the first adapter portion toward the shaft and disposed to be spaced apart from the inner race of the bearing portion.

The second adapter portion may form a step with the first adapter portion.

The distance between the first adapter portion and the shaft may be greater than the distance between the second adapter portion and the shaft.

The adapter may have an annular shape through which the shaft passes.

The bearing portion may be a tapered roller bearing.

The bearing portion may include a first bearing and a second bearing disposed adjacent to each other, and the bearing unit according to the present disclosure may further include a distance-adjusting unit disposed between the first bearing and the second bearing and configured to adjust the distance between the first bearing and the second bearing.

The distance-adjusting unit may have an annular shape through which the shaft passes.

A roller assembly according to the present disclosure is a roller assembly for press-molding powder into a sheet-type electrode or for conveying a sheet-type electrode. The roller assembly includes a roller, a shaft extending from the roller, and a bearing unit including a bearing portion configured to rotatably support the shaft and a piston unit configured to apply an external force to the bearing portion in an axial direction of the shaft. The bearing portion includes an inner race coupled to the shaft and configured to rotate together with the shaft, and an outer race surrounding the inner race such that the inner race is disposed in an inner portion of the outer race. The piston unit includes a first piston disposed on one side of the bearing portion and a second piston disposed on the other side of the bearing portion. When the inner race of the bearing portion moves in a direction in which the inner race deviates from an inner portion of the outer race of the bearing portion and an axial clearance is generated between the inner race and the outer race of the bearing portion, the first piston is configured to push and move the outer race of the bearing portion so as to eliminate the axial clearance, and the second piston is configured to push and move the outer race of the bearing portion such that the inner race deviates from the inner portion of the outer race of the bearing portion when the axial clearance is eliminated by the first piston. The direction in which the first piston pushes the outer race of the bearing portion and the direction in which the second piston pushes the outer race of the bearing portion may be opposite to each other.

With a bearing unit according to the present disclosure and a roller assembly including the same, an axial clearance between an inner race and an outer race of a bearing portion supporting a rotation shaft of a roller may be adjusted to an appropriate state.

In addition, according to the present disclosure, durability or a lifespan of a bearing portion supporting a roller may be improved.

The effects of the present disclosure are not limited to those described above, and other effects not mentioned herein may be clearly understood by a person ordinarily skilled in the art to which the present disclosure pertains from the present specification and the accompanying drawings.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a perspective view illustrating a roller assembly according to the present disclosure.

FIG. 2 is a cross-sectional view taken along the line 1-1 of FIG. 1.

FIG. 3 is a perspective view illustrating a bearing portion according to the present disclosure.

FIG. 4 is an enlarged view illustrating portion A of FIG. 2.

FIG. 5 is an enlarged view illustrating portion B of FIG. 4.

FIG. 6 is a view illustrating a state in which inner races have moved in FIG. 5.

FIG. 7 is a view illustrating a state in which a first piston has pushed an outer race from the state illustrated in FIG. 6, and an axial clearance between each pair of inner and outer races has been eliminated.

FIG. 8 is a view illustrating a state in which a second piston has pushed an outer race from the state illustrated in FIG. 7, and an appropriate axial clearance between each pair of inner and outer races has been generated.

FIG. 9 is a block diagram illustrating a control configuration of a roller assembly according to the present disclosure.

FIG. 10 is a block diagram illustrating a hardware configuration implementing a controller according to the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, with reference to the accompanying drawings, embodiments of the present disclosure will be described so that those ordinarily skilled in the art can easily implement the present disclosure. However, the present disclosure may be implemented in various different forms and is not limited or restricted by the following examples.

In order to clearly describe the present disclosure, detailed descriptions of portions unrelated to the present disclosure or known technologies that may unnecessarily obscure the gist of the present disclosure have been omitted. Additionally, when assigning reference numerals to components in each drawing in this specification, the same or similar reference numerals are assigned to the same or similar components throughout the specification.

In addition, the terms or words used in the specification and claims should not be construed as limited to their ordinary or dictionary meanings, but should be construed as meanings and concepts consistent with the technical idea of the present disclosure based on the principle that an inventor may appropriately define the concepts of terms in order to explain their invention in the best way.

In a manufacturing process of the secondary batteries, powder and/or an electrode is often molded or conveyed while being heated to a predetermined temperature. Accordingly, a deformation due to the heat such as, for example, a thermal expansion, may occur in a roller along the axial direction. When a thermal expansion occurs in the roller, a thermal stress may be applied to a bearing portion supporting the roller, and such thermal stress may cause deterioration in durability of the bearing portion, increased fatigue, and shortened lifespan.

In addition, when a thermal expansion occurs in the roller, the components constituting the bearing portion may deviate from their rated positions, and thus, a clearance of the bearing portion may change. Such a change in the clearance may substantially affect an electrode having a very small thickness.

Meanwhile, as a bearing that supports the roller, a roller bearing having an internal rotating member with a cylindrical or truncated cone shape may be required. However, when a roller bearing that does not sufficiently support an axial load is used, the thermal expansion of the roller may increase or decrease the clearance between an inner race and an outer race of the roller bearing beyond a set range. The clearance between the inner race and the outer race of the roller bearing needs to be set within an appropriate range in order to distribute a load applied to the internal rotating member, optimize lubrication, and minimize noise and vibration. However, when the clearance increases beyond the set range, excessive noise and vibration may occur in the roller, and precision may be degraded, causing a variation in thickness in the electrode. Alternatively, when the clearance decreases beyond the set range, an excessive load may be applied to the bearing, causing a degraded durability and shortened lifespan of the bearing.

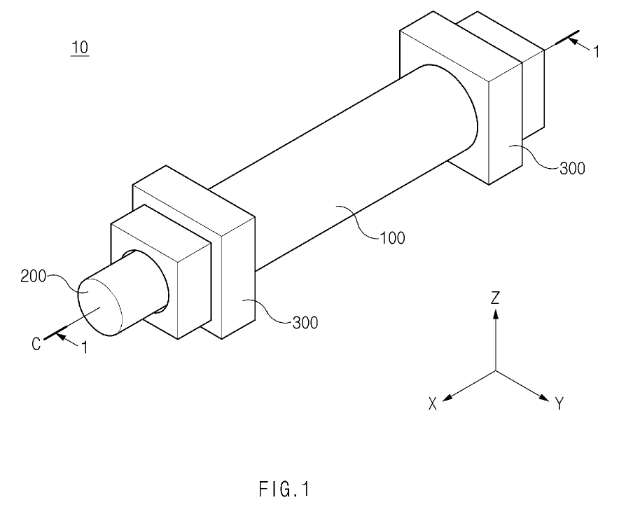

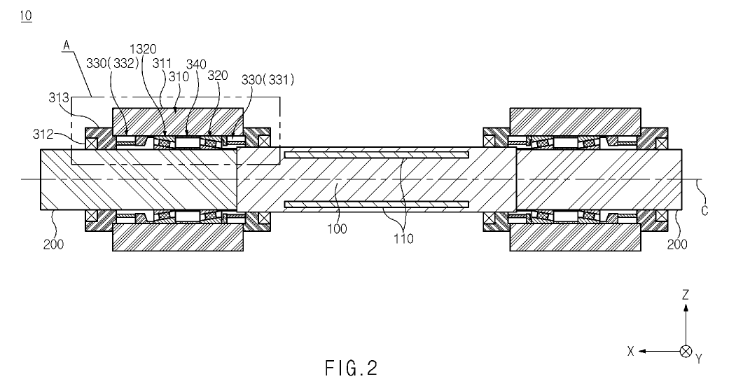

FIG. 1 is a perspective view illustrating a roller assembly according to an embodiment of the present disclosure, and FIG. 2 is a cross-sectional view taken along the line 1-1 of FIG. 1.

Referring to FIGS. 1 and 2, the roller assembly 10 according to an embodiment of the present disclosure may be used to manufacture an electrode for a secondary battery, and may include a roller 100, a shaft 200, and a bearing unit 300.

Although not illustrated in the drawings, a pair of roller assemblies 10 may be provided and disposed parallel to each other to press-mold powder into a sheet-type electrode or to convey a sheet-type electrode.

A predetermined space (hereinafter, referred to as a “gap”) may be formed between the pair of roller assemblies 10 disposed parallel to each other. In addition, the rollers 100 of the pair of roller assemblies 10 may rotate in opposite directions.

Powder, which is a raw material of an electrode, may be introduced into the gap. The powder may be pressed by the pair of roller assemblies 10, and a sheet-type electrode may be manufactured. Here, the powder may be a slurry in which, for example, an electrode active material, a binder, and a conductive material are mixed.

A sheet-type electrode, which is an object to be conveyed, may also be introduced into the gap. In this case, when the rollers 100 of the roller assemblies 10 rotate, both surfaces of the sheet-type electrode may be in close contact with outer circumferential surfaces of the pair of rollers 100, respectively, and may be conveyed in a specific direction by the friction with the rollers 100.

Referring to FIGS. 1 and 2, the roller 100 of the roller assembly 10 according to an embodiment of the present disclosure may have a cylindrical shape elongated in a front-rear direction (e.g., an X-axis direction). In this case, the direction in which the roller 100 is arranged is not particularly limited.

In the present disclosure, a central axis passing through the center along the length direction of the roller 100 (e.g., the X-axis direction) may coincide with a rotation axis (hereinafter, referred to as an "axis C") serving as a center of rotation of the roller 100. For example, the roller 100 may rotate about the central axis. However, the present disclosure is not limited thereto, and the axis C of the roller 100 may be displaced in parallel from the central axis, so that the roller 100 may rotate eccentrically. Hereinafter, for the convenience of description, the central axis and the axis C of the roller 100 will be described as coinciding with each other.

In the meantime, the roller assembly 10 may include a heating unit 110. The heating unit 110 may apply heat to the roller 100. Accordingly, the heating unit 110 may heat the powder press-molded by the roller 100 or a sheet-type electrode conveyed by the roller 100 to a predetermined temperature, or may maintain the temperature within a specific range.

In this case, the heating unit 110 may be an electric heater provided inside the roller 100. Alternatively, the heating unit 110 may be a flow path provided inside the roller 100. For example, a high-temperature fluid may flow in the flow path. However, the structure or the type of the heating unit 110 is not particularly limited as long as heat can be applied to the roller 100.

The roller assembly 10 according to an embodiment of the present disclosure may include a shaft 200. The shaft 200 may extend from the roller 100. The shaft 200 may extend in an axial direction (e.g., an X-axis direction) (hereinafter, referred to as an “axis C direction of the shaft 200”). A pair of shafts 200 may be respectively provided on opposite sides of the roller 100 in a length direction (e.g., the X-axis direction).

The shaft 200 may transmit a driving force to the roller 100 so as to rotate the roller 100. To this end, one side of the shaft 200 may be operatively connected to an actuator (not illustrated). Meanwhile, the shaft 200 and the roller 100 may share the same central axis, and accordingly, central axes of the shaft 200 may also coincide with the axis C, such that the shaft 200 may also rotate about the central axis. Accordingly, the roller 100 and the shaft 200 may rotate concentrically together.

The roller assembly 10 according to an embodiment of the present disclosure may include a bearing unit 300.

The bearing unit 300 may be coupled to the shaft 200. For example, the bearing unit 300 may rotatably support the shaft 200, thereby indirectly supporting the roller 100.

A pair of bearing units 300 may be provided in one roller assembly 10. The pair of bearing units 300 may respectively support a pair of shafts 200. Hereinafter, for the convenience of description, a single bearing unit 300 will be described.

Referring to FIG. 2, the bearing unit 300 according to the present disclosure may include a bearing housing 310.

The bearing housing 310 may form an overall appearance of the bearing unit 300, and may accommodate other components of the bearing unit 300 therein.

The bearing housing 310 may include a housing unit 311, a sealing unit 312, and a sealing cover unit 313.

The housing unit 311 may be made of a material having predetermined rigidity, such as metal or plastic. The housing unit 311 may surround the shaft 200 in a circumferential direction around the axis C. The housing unit 311 may have a predetermined length in a direction extending along the axis C (e.g., the X-axis direction).

Accordingly, a predetermined inner space may be formed between an inner surface of the housing unit 311 and an outer circumferential surface of the shaft 200, and remaining components of the bearing unit 300 other than the bearing housing 310 may be accommodated in the inner space. Through this, the housing unit 311 may protect the remaining components of the bearing unit 300, other than the bearing housing 310, from the external impact or contamination.

According to an embodiment, a predetermined fluid may be accommodated in the inner space of the housing unit 311. For example, a lubrication fluid for smooth operation of the bearing portion 320, 1320 may be accommodated in the inner space of the housing unit 311. Accordingly, the inner space needs to be isolated from the outside so that the fluid does not leak.

The sealing unit 312 may isolate the inner space from the outside, and thus, the fluid in the inner space may not leak to the outside. According to an embodiment, the sealing unit 312 may include a sealing member configured to isolate the inner space from the outside. For example, the sealing unit 312 may include an O-ring made of rubber or plastic, or may include a gasket made of an elastic material such as rubber or silicone. However, the shape or material of the sealing unit 312 is not particularly limited as long as the fluid in the inner space is prevented from leaking to the outside.

A pair of sealing units 312 may be provided. The pair of sealing units 312 may be respectively provided on opposite sides of the housing unit 311 in the length direction (e.g., the X-axis direction). The sealing units 312 may be formed in close contact with an outer circumferential surface of the shaft 200 or the roller 100. The sealing units 312 may prevent the fluid in the inner space from leaking to both sides of the housing unit 311 in the length direction (e.g., the X-axis direction).

The sealing cover unit 313 may fix the position of the sealing unit 312 and prevent the sealing unit 312 from deviating from a proper position. The sealing cover unit 313 may have a socket structure in which the sealing unit 312 may be mounted or installed. A pair of sealing cover units 313 may be provided. The pair of sealing cover units 313 may respectively fix a pair of sealing units 312. The structure of the sealing cover units 313 is not particularly limited as long as the sealing units 312 can be fixed.

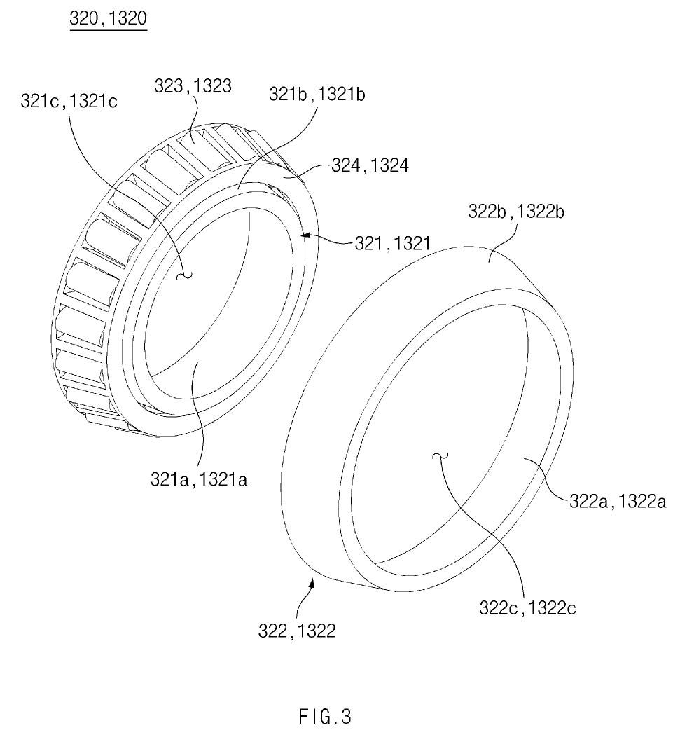

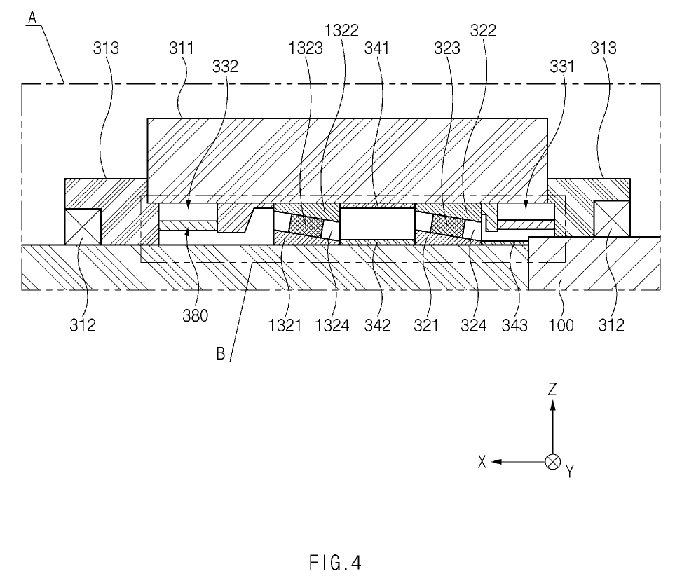

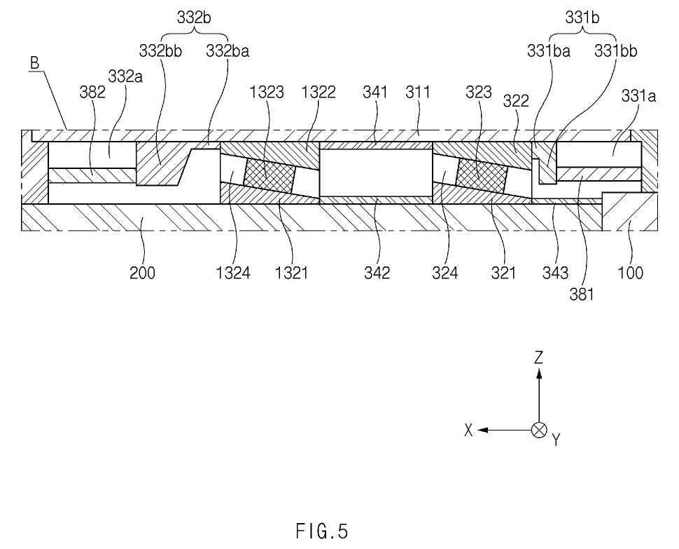

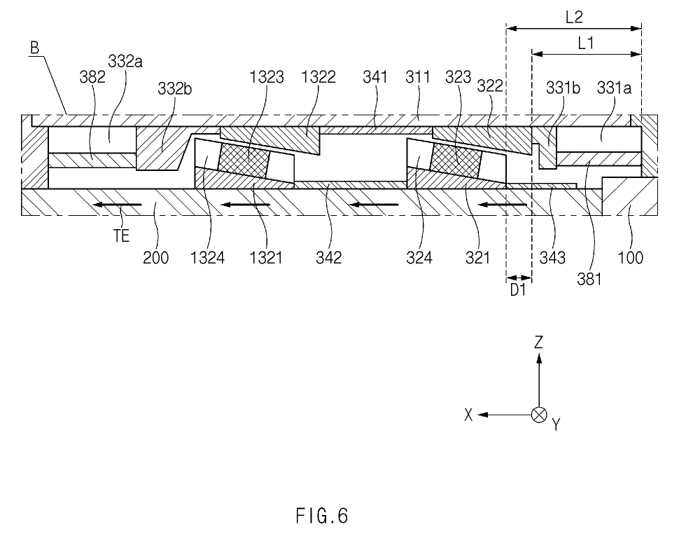

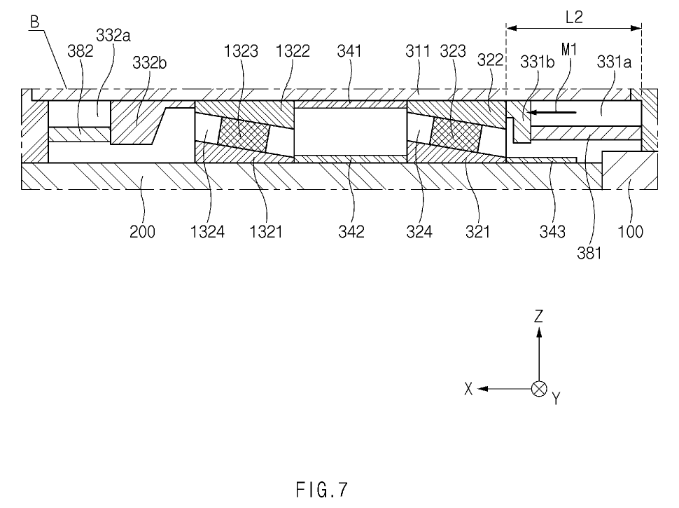

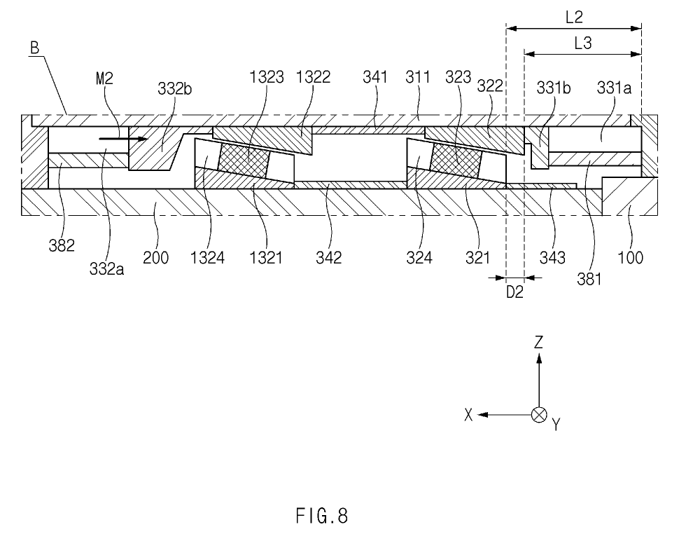

FIG. 3 is a perspective view illustrating a bearing portion according to the present disclosure, FIG. 4 is an enlarged view illustrating portion A of FIG. 2, FIG. 5 is an enlarged view illustrating portion B of FIG. 4, FIG. 6 is a view illustrating a state in which an inner race has moved in FIG. 5, FIG. 7 is a view illustrating a state in which a first piston pushes an outer race to remove an axial clearance between the inner race and the outer race in FIG. 6, and FIG. 8 is a view illustrating a state in which a second piston pushes the outer race to generate an appropriate axial clearance between the inner race and the outer race in FIG. 7.

Referring to FIGS. 3 to 8, the bearing unit 300 according to the present disclosure may further include a bearing portion 320, 1320 and a piston unit 330.

The bearing portion 320, 1320, which rotatably supports the shaft 200, may be accommodated in the inner space of the housing unit 311 of the bearing housing 310. In this case, when the rollers 100 of the pair of roller assemblies 10 roll or convey a specific sheet, the load acting in a radial direction on the bearing portion 320, 1320 may be greater than the load acting in an axial direction. Accordingly, the bearing portion 320, 1320 may be a bearing that sufficiently supports the radial load even though the bearing portion 320, 1320 does not sufficiently support the axial load acting on the shaft 200. For example, the bearing portion 320, 1320 may be a taper roller bearing in which an inner race 321, 1321 is inserted into an outer race 322, 1322. In this case, when the bearing portion 320, 1320 does not sufficiently support the axial load acting on the shaft 200, the clearance in the axis C direction between the inner race 321, 1321 and the outer race 322, 1322 may deviate from an appropriate state. The clearance in the axis C direction may be set to an appropriate state by the piston unit 330, which will be described below.

Meanwhile, the bearing unit 300 according to the present disclosure may include a single bearing portion (e.g., a first bearing 320 or a second bearing 1320) and a pair of piston units (e.g., a first piston 331 and a second piston 332) respectively disposed on opposite sides of the single bearing portion (e.g., the first bearing 320 or the second bearing 1320).

Alternatively, the bearing unit 300 according to the present disclosure may include a pair of bearing portions 320, 1320 and a pair of piston units (e.g., a first piston 331 and a second piston 332) respectively disposed on opposite sides of the pair of bearing portions 320, 1320 (see, e.g., FIG. 4). For example, the bearing portions 320, 1320 may include a first bearing 320 and a second bearing 1320 disposed adjacent to each other, and the piston unit 330 may include a first piston 331 and a second piston 332 respectively disposed outside the first bearing 320 and the second bearing 1320. According to an embodiment, the first piston 331 may be disposed on one side of the first bearing 320 in the axis C direction of the shaft 200, and the second piston 332 may be disposed on the other side of the second bearing 1320 in the axis C direction of the shaft 200.

In this case, a distance-adjusting unit 340 may be disposed between the first bearing 320 and the second bearing 1320, but the first bearing 320 and the second bearing 1320 may also be in contact with each other. When the first bearing 320 and the second bearing 1320 are in contact with each other, the outer race 322 of the first bearing 320 and the outer race 1322 of the second bearing 1320 may be in contact with each other. In this case, when an external force is applied to one of the outer race 322 of the first bearing 320 and the outer race of the second bearing 1320, the external force may be transmitted to the other outer race.

Hereinafter, each of the bearing portion 320, 1320 and a piston unit 330 will be described.

Referring to FIGS. 2 to 4, a bearing portion 320, 1320 may include an inner race 321, 1321, an outer race 322, 1322, a rotating member 323, 1323, and a holder 324, 1324.

The inner race 321, 1321 of the bearing portion 320, 1320 may be coupled to the shaft 200 and may rotate together with the shaft 200. In this case, since the shaft 200 rotates about the axis C, the inner race 321, 1321 may also rotate about the axis C of the shaft 200.

The inner race 321, 1321 may be fixed to the shaft 200 and may rotate together with the shaft 200 according to the rotation of the shaft 200. According to an embodiment, the inner race 321, 1321 may be formed in a ring shape, and the shaft 200 may be inserted into and fixed to an inner portion 321c, 1321c of the inner race 321, 1321 surrounded by inner circumferential surface 321a, 1321a of the inner race 321, 1321. The inner race 321, 1321 may be directly fixed to the shaft 200 by, for example, welding, but the present disclosure is not limited thereto, and the inner race 321, 1321 may be fixed using a separate member.

When the shaft 200 and/or the roller 100 undergo a thermal expansion (TE), the direction in which a thermal expansion (TE) occurs may be the axis C direction of the shaft 200. Accordingly, when the shaft 200 and/or the roller 100 undergo a thermal expansion (TE), the inner race 321, 1321 may move together with the shaft 200 in the axis C direction of the shaft 200.

Meanwhile, the outer race 322, 1322 of the bearing portion 320, 1320 may surround the inner race 321, 1321. For example, an inner circumferential surface 322a, 1322a of the outer race 322, 1322 may surround an outer circumferential surface 321b, 1321b of the inner race 321, 1321 while being spaced apart therefrom. To this end, the outer race 322, 1322 may be formed in a ring shape, and the inner diameter of the outer race 322, 1322 may be greater than the outer diameter of the inner race 321, 1321.

The inner race 321, 1321, the rotating member 323, 1323, and the holder 324, 1324 may be disposed in the inner portion 322c, 1322c of the outer race 322, 1322 of the bearing portion 320, 1320. For example, the holder 324, 1324 may be disposed in the inner portion 322c, 1322c of the outer race 322, 1322, and the inner race 321, 1321 may be disposed inside the holder 324, 1324. In this case, the inner portion 322c, 1322c of the outer race 322, 1322 may refer to a space surrounded by the inner circumferential surface 322a, 1322a of the outer race 322, 1322.

The outer race 322, 1322 of the bearing portion 320, 1320 may be interference-fitted into the housing unit 311 of the bearing housing 310. Here, “interference-fitted” means that the outer race 322, 1322 is inserted while being supported by the housing unit 311 such that the outer circumferential surface 322b, 1322b of the outer race 322, 1322 is in direct contact with the inner circumferential surface of the housing unit 311 so that frictional force is applied therebetween.

The outer race 322, 1322 of the bearing portion 320, 1320 may be supported at outer circumferential surface 322b, 1322b thereof by the housing unit 311 of the bearing housing 310, and may not be fixed to the inner race 321, 1321. Accordingly, even when the shaft 200 and the inner race 321, 1321 rotate, the outer race 322, 1322 may not rotate since the outer race 322, 1322 is supported by the housing unit 311.

As described above, when the shaft 200 and/or the roller 100 undergo a thermal expansion (TE), the inner race 321, 1321 may move together with the shaft 200 in the axis C direction of the shaft 200. Meanwhile, since the outer race 322, 1322 of the bearing portion 320, 1320 is interference-fitted into and fixed to the bearing housing 310, when the shaft 200 and/or the roller 100 thermally expands (TE) and the inner race 321, 1321 moves, the inner race 321, 1321 moves in a direction in which the inner race 321, 1321 deviates from the inner portion of the outer race 322, 1322.

The rotating member 323, 1323 of the bearing portion 320, 1320 may support the inner race 321, 1321 to be rotatable relative to the outer race 322, 1322. The rotating member 323, 1323 may be disposed between the inner race 321, 1321 and the outer race 322, 1322, and may indirectly connect the inner race 321, 1321 and the outer race 322, 1322. The rotating member 323, 1323 may have a cylindrical or truncated cone shape, but the shape thereof is not particularly limited.

The holder 324, 1324 of the bearing portion 320, 1320 may be disposed between the inner race 321, 1321 and the outer race 322, 1322, and may rotatably support the rotating member 323, 1323. The holder 324, 1324 may be provided with a space accommodating the rotating member 323, 1323, and the rotating member 323, 1323 accommodated in the space may roll while being in contact with the inner race 321, 1321 and the outer race 322, 1322, respectively.

As described above, in the bearing portion 320, 1320, the rotating member 323, 1323 may have a cylindrical or truncated cone shape, and the inner race 321, 1321 may be inserted into the outer race 322, 1322. Accordingly, the bearing portion 320, 1320 may sufficiently support a radial load acting on the shaft 200. However, the bearing portion 320, 1320 may not sufficiently support an axial load acting on the shaft 200. Accordingly, when the shaft 200 moves in the axis C direction (e.g., the X-axis direction) due to a thermal expansion (TE) of the roller 100 and/or the shaft 200, the inner race 321, 1321 may move in a direction in which the inner race 321, 1321 deviates from the inner portion of the outer race 322, 1322, thereby increasing the clearance in the axis C direction between the inner race 321, 1321 and the outer race 322, 1322 or causing an excessive load to act on the outer race 322, 1322.

Accordingly, the piston unit 330 according to the present disclosure may appropriately adjust the clearance in the axis C direction between the inner race 321, 1321 and the outer race 322, 1322 of the bearing portion 320, 1320.

The clearance in the axis C direction between the inner race 321, 1321 and the outer race 322, 1322 of each of the bearing portions 320, 1320 may refer to a degree to which an axial separation in the axis C direction between the inner race 321 or 1321 and the outer race 322 or 1322 deviates from a predetermined separation.

For example, FIG. 5 illustrates a state in which the clearance in the axis C direction (e.g., the clearance in the axis C direction is zero) has been eliminated as the inner race 321, 1321, the rotating member 323, 1323, and the holder 324, 1324 of each of the bearing portions 320, 1320 have been coupled to the outer race 322, 1322 at proper positions, and FIG. 6 illustrates a state in which a clearance in the axis C direction has been generated between the inner race 321, 1321 and the outer races 322, 1322 as the shaft 200 and/or the roller 100 undergo a thermal expansion(TE) to move the inner race 321, 1321 by a first distance D1 in the axis C direction.

Referring to FIG. 5, the state in which the clearance in the axis C direction between the inner race 321, 1321 and the outer race 322, 1322 of each of the bearing portions 320, 1320 has been eliminated may refer to a state in which a relative positional change between the inner race 321, 1321 and the outer race 322, 1322 is restricted.

For example, when the bearing portion 320, 1320 is a taper roller bearing, the state in which a clearance in the axis C direction between the inner race 321, 1321 and the outer race 322, 1322 of each of the bearing portions 320, 1320 has been eliminated may refer to a state in which the inner race 321, 1321 and the outer race 322, 1322 are in contact with the rotating member 323, 1323.

Alternatively, the state in which the clearance in the axis C direction between the inner race 321, 1321 and the outer race 322, 1322 of each of the bearing portions 320, 1320 has been eliminated may refer to a state in which the inner race 321, 1321 and the outer race 322, 1322 are coupled to each other at proper positions. In this case, the state in which the inner race 321, 1321 and the outer race 322, 1322 are coupled to each other at proper positions may refer to a state in which opposite ends of the inner race 321, 1321 in the axis C direction are disposed in the inner portion 322c, 1322c of the outer race 322, 1322.

Referring to FIG. 6, a state in which a clearance in the axis C direction has been generated between the inner race 321, 1321 and the outer race 322, 1322 of the bearing portion 320, 1320 may refer to a state in which a relative positional change between the inner race 321, 1321 and the outer race 322, 1322 is allowed.

For example, when the bearing portion 320, 1320 is a taper roller bearing, the state in which clearance in the axis C direction between the inner race 321, 1321 and the outer race 322, 1322 has been generated may refer to a state in which at least one of the inner race 321, 1321 and the outer race 322, 1322 is not in contact with the rotating member 323, 1323.

Alternatively, the state in which a clearance in the axis C direction has been generated between the inner race 321, 1321 and the outer race 322, 1322 of each of the bearing portions 320, 1320 may be a state in which the inner race 321, 1321 has deviated from a proper position relative to the outer race 322, 1322 by a predetermined distance in the axis C direction. The proper positions may refer to a state in which, as illustrated in FIG. 5, the rotating members 323, 1323 of the bearing portion 320, 1320 are in contact with the inner race 321, 1321 and the outer race 322, 1322.

Alternatively, the state in which a clearance in the axis C direction has been generated between the inner race 321, 1321 and the outer race 322, 1322 of each of the bearing portions 320, 1320 may refer to a state in which the inner race 321, 1321 has at least partially deviated from the inner portion 322c, 1322c.

Alternatively, the clearance in the axis C direction between the inner race 321, 1321 and the outer race 322, 1322 of each of the bearing portions 320, 1320 may refer to an axial separation between the inner race 321, 1321 and the outer race 322, 1322 in the axis C direction. Alternatively, the clearance in the axis C direction between the inner race 321, 1321 and the outer race 322, 1322 may refer to an axial gap or play between the inner race 321, 1321 and the outer race 322, 1322 in the axis C direction. Accordingly, a state in which the clearance in the axis C direction between the inner race 321, 1321 and the outer race 322, 1322 has been eliminated may refer to a state in which the axial gap or play in the axis C direction between the inner race 321, 1321 and the outer race 322, 1322 has been eliminated. In other words, a state in which the clearance between the inner race 321, 1321 and the outer race 322, 1322 is zero may refer to a state in which the axial gap or play in the axis C direction between the inner race 321, 1321 and the outer race 322, 1322 is zero. In addition, a state in which a clearance in the axis C direction between the inner race 321, 1321 and the outer race 322, 1322 has been generated may refer to a state in which an axial gap or play in the axis C direction between the inner race 321, 1321 and the outer race 322, 1322 has been generated.

After removing an excessive clearance in the axis C direction between the inner race 321, 1321 and the outer race 322, 1322 of the bearing portion 320, 1320 through the first piston 331, the piston unit 330 according to the present disclosure may intentionally generate a small amount of clearance in the axis C direction through the second piston 332, thereby maintaining an appropriate clearance required to operate the bearing unit 300.

Meanwhile, referring to FIGS. 4 to 8, the piston unit 330 according to the present disclosure may apply an external force to the bearing portion 320, 1320 in the axis C direction of the shaft 200, and may include a first piston 331 and a second piston 332.

The first piston 331 may be disposed on one side of the bearing portion 320, 1320, and may push and move the outer race 322, 1322 in a direction of thermal expansion (TE) of the shaft 200 and/or the roller 100.

For example, when the shaft 200 and/or the roller 100 undergo a thermal expansion (TE), and thus a clearance in the axis C direction has been generated between the inner race 321, 1321 and the outer race 322, 1322 of each of the bearing portions 320, 1320, the first piston 331 may push and move the outer race 322, 1322 such that the clearance in the axis C direction is eliminated.

As an example, when the shaft 200 and/or the roller 100 undergo a thermal expansion (TE), and thus the inner race 321, 1321 and/or the outer race 322, 1322 of the bearing portion 320, 1320 is spaced apart from the rotating member 323, 1323, the first piston 331 may push and move the outer race 322, 1322 such that the inner race 321, 1321 and the outer race 322, 1322 are brought into contact with the rotating member 323, 1323.

As another example, when the shaft 200 and/or the roller 100 undergo a thermal expansion (TE), and thus the inner race 321, 1321 of the bearing portion 320, 1320 deviates from the inner portion 322c, 1322c of the outer race 322, 1322, the first piston 331 may push and move the outer race 322, 1322 such that opposite ends of the inner race 321, 1321 in the axis C direction are disposed in the inner portion 322c, 1322c of the outer race 322, 1322.

The second piston 332 may be disposed on the other side of the bearing portion 320, 1320, and when a clearance in the axis C direction between the inner race 321, 1321 and the outer race 322, 1322 is eliminated by the first piston 331, the second piston 332 may push and move the outer race 322, 1322 such that the inner race 321, 1321 deivates from the inner portion 322c, 1322c of the outer race 322, 1322.

As an example, when the outer race 322, 1322 of the bearing portion 320, 1320 is moved by the first piston 331 and thus the inner race 321, 1321 and the outer race 322, 1322 is brought into contact with the rotating member 323, 1323, the second piston 332 may push and move the outer race 322, 1322 such that the inner race 321, 1321 and/or the outer race 322, 1322 is spaced apart from the rotating member 323, 1323.

As another example, when the outer race 322, 1322 of the bearing portion 320, 1320 is moved by the first piston 331 and opposite ends of the inner race 321, 1321 in the axis C direction is disposed in the inner portion 322c, 1322c of the outer race 322, 1322, the second piston 332 may push and move the outer race 322, 1322 such that the inner race 321, 1321 at least partially deviates from the inner portion 322c, 1322c of the outer race 322, 1322.

In this case, the direction in which the first piston 331 pushes the outer race 322, 1322 of the bearing portion 320, 1320 and the direction in which the second piston 332 pushes the outer race 322, 1322 may be opposite to each other. For example, when the first piston 331 pushes the outer race 322, 1322 in a specific direction to remove clearance in the axis C direction between the inner race 321, 1321 and the outer race 322, 1322, the second piston 332 may then push the outer race 322, 1322 in a direction opposite to the direction in which the first piston 331 pushes the outer race 322, 1322, thereby generating a small clearance in the axis C direction between the inner race 321, 1321 and the outer race 322, 1322.

Meanwhile, in the present embodiment, the first piston 331 and the second piston 332 are configured to respectively push the outer races 322, 1322 of the bearing portions 320, 1320 to remove or generate a clearance, but the pushing manner of the first piston 331 and the second piston 332 is not limited thereto. For example, the first piston 331 and the second piston 332 may respectively push the inner races 321, 1321 of the bearing portions 320, 1320 to remove or generate a clearance.

Referring to FIGS. 4 to 8, the first piston 331 according to the present disclosure may include a first piston member 331a and a first adapter 331b, and the second piston 332 may include a second piston member 332a and a second adapter 332b. Hereinafter, the first piston member 331a and the second piston member 332a will be collectively referred to as a piston member 331a, 332a, and the first adapter 331b and the second adapter 332b will be collectively referred to as an adapter 331b, 332b.

The piston member 331a, 332a may reciprocate along the axis C direction of the shaft 200. A servo valve (not illustrated) may be connected to one side of the piston member 331a, 332a, and the servo valve may generate a driving force to allow the piston member 331a, 332a to reciprocate.

In this case, the first piston member 331a of the first piston 331 and the piston member 332a of the second piston 332 may move in the same direction. For example, when the first piston member 331a moves to one side in the axis C direction of the shaft 200, the second piston member 332a may move to one side in the axis C direction of the shaft 200. Through this, when one of the first piston 331 and the second piston 332 pushes the outer race 322, 1322 of the bearing portion 320, 1320, the other piston may support the outer race 322, 1322 on the opposite side.

The piston member 331a, 332a may reciprocate while being guided by the bearing housing 310. For example, the piston member 331a, 332a may be formed in an annular shape through which the shaft 200 passes, and a portion of an outer circumferential surface of the piston member 331a, 332a may reciprocate along the axis C direction of the shaft 200 while being in contact with an inner circumferential surface of the housing unit 311 of the bearing housing 310 and being guided by the housing unit 311.

The adapter 331b, 332b may be disposed at an end of the piston member 331a, 332a facing the outer race 322, 1322, and may move together with the piston member 331a, 332a. The adapter 331b, 332b may take a role of apply an external force to the outer race 322, 1322 of the bearing portion 320, 1320 when the piston member 331a, 332a is driven. For example, the adapter 331b of the first piston 331 may apply an external force to the outer race 322 of the first bearing 320, and the adapter 332b of the second piston 332 may apply an external force to the outer race 1322 of the second bearing 1320.

When the piston member 331a, 332a move in a direction toward the outer race 322, 1322 of the bearing portion 320, 1320, the adapter 331b, 332b may apply an external force to the outer race 322, 1322. In this case, the adapter 331b, 332b may be formed in an annular shape through which the shaft 200 passes, but the shape thereof is not particularly limited.

The adapter 331b, 332b may include a first adapter portion 331ba, 332ba and a second adapter portion 331bb, 332bb.

The first adapter portion 331ba, 332ba may be in contact with the outer race 322, 1322 so as to support the outer race 322, 1322 of the bearing portion 320, 1320.

The first adapter portion 331ba, 332ba may have an annular shape through which the shaft 200 passes. The first adapter portion 331ba, 332ba may have a predetermined thickness in the axis C direction (e.g., the X-axis direction) of the shaft 200.

A portion of the first adapter portion 331ba, 332ba that is in contact with the outer race 322, 1322 of the bearing portion 320, 1320 may be formed as a flat surface so as to stably support the outer race 322, 1322. In this case, the flat surface of the outer race 322, 1322 may extend in a direction perpendicular to the axis C direction (e.g., the X-axis direction) of the shaft 200 (e.g., the Y-axis direction and the Z-axis direction).

The second adapter portion 331bb, 332bb may extend from the first adapter portion 331ba, 332ba toward the shaft 200, and may be disposed to be spaced apart from the inner race 321, 1321 of the bearing portion 320, 1320. The second adapter portion 331bb, 332bb may have an annular shape through which the shaft 200 passes. The second adapter portion 331bb, 332bb may have a predetermined thickness in the axis C direction (e.g., the X-axis direction) of the shaft 200.

At least a portion of the second adapter portion 331bb, 332bb may be disposed to face the inner race 321, 1321 of the bearing portion 320, 1320. In this case, at least a portion of the second adapter portion 331bb, 332bb facing the inner race 321, 1321 may be disposed to be spaced apart from the inner race 321, 1321. This configuration is intended to avoid an interference between the inner race 321, 1321 of the bearing portion 320, 1320 and the second adapter portion 331bb, 332bb during the process where the clearance value of the bearing unit 300 is adjusted.

The second adapter portion 331bb, 332bb may form a step with the first adapter portion 331ba, 332ba. The second adapter portion 331bb, 332bb may well be formed to be inclined with respect to the first adapter portion 331ba, 332ba.

The first adapter portion 331ba, 332ba and the second adapter portion 331bb, 332bb may be spaced apart from the shaft 200. This is intended to avoid an interference between the shaft 200 and the adapter 331b, 332b when the shaft 200 rotates about the axis C. To this end, the adapter 331b, 332b may be interference-fitted into the housing unit 311 of the bearing housing 310.

The distance between the first adapter portion 331ba, 332ba and the shaft 200 may be greater than the distance between the second adapter portion 331bb, 332bb and the shaft 200. Accordingly, since the first adapter portion 331ba, 332ba do not contact the inner race 321, 1321 of the bearing portion 320, 1320, an external force may be concentrated only on the outer race 322, 1322.

A roller assembly 10 according to another embodiment of the present disclosure may have a piston unit 330 modified in shape such that a portion of the first piston 331 contacts the outer race 322 of the first bearing 320 and a remaining portion of the first piston 331 does not contact the inner race 321 of the first bearing 320, and a portion of the second piston 332 contacts the outer race 1322 of the second bearing 1320 and a remaining portion of the second piston 332 does not contact the inner race 1321 of the second bearing 1320. In this case, since the piston unit 330 does not contact the inner race 321, 1321, the piston unit 330 may not interfere with the rotation of the inner race 321, 1321. In this embodiment, even when the adapter 331b, 332b is not provided, the piston unit 330 may push and move the outer race 322, 1322 in the axis C direction (e.g., the X-axis direction) of the shaft.

Meanwhile, referring to FIGS. 4 to 8, the bearing unit 300 according to the present disclosure may further include a distance-adjusting unit 340.

The distance-adjusting unit 340 may include a first distance-adjusting member 341, a second distance-adjusting member 342, and a third distance-adjusting member 343.

The first distance-adjusting member 341 may be disposed between the pair of bearing portions 320, 1320 to adjust the distance between the pair of bearing portions 320, 1320 disposed adjacent to each other. For example, the first distance-adjusting member 341 may be disposed between the pair of outer races 322, 1322 to adjust the distance between the pair of outer races 322, 1322 disposed adjacent to each other.

The first distance-adjusting member 341 may have an annular or cylindrical shape through which the shaft 200 passes. The first distance-adjusting member 341 may correspond in diameter to the outer races 322, 1322 of the bearing portions 320, 1320. Here, “correspond” may mean that the outer diameter of the first distance-adjusting member 341 is identical to the outer diameter of each of the outer races 322, 1322, and the inner diameter of the first distance-adjusting member 341 is greater than or equal to the inner diameter of each of the outer races 322, 1322. Accordingly, the first distance-adjusting member 341 may not interfere with the rotation of the inner races 321, 1321.

In this case, the first distance-adjusting member 341 may have a predetermined length in the axis C direction (e.g., the X-axis direction). The opposite sides of the first distance-adjusting member 341 in the length direction (e.g., the X-axis direction) may respectively contact the pair of outer races 322, 1322. The length of the first distance-adjusting member 341 may function as a rated distance between the pair of outer races 322, 1322.

Meanwhile, since the first distance-adjusting member 341 is fitted between the outer race 322 of the first bearing 320 and the outer race 1322 of the second bearing 1320, when an external force is applied to one of the pair of outer races 322, 1322, the first distance-adjusting member 341 may serve to transmit the external force to the other outer race. As an example, when the first piston 331 pushes the outer race 322 of the first bearing 320 by applying an external force thereto, the first distance-adjusting member 341 may transmit the external force to the outer race 1322 of the second bearing 1320. As another example, when the second piston 332 pushes the outer race 1322 of the second bearing 1320 by applying an external force thereto, the first distance-adjusting member 341 may transmit the external force to the outer race 322 of the first bearing 320.

The second distance-adjusting member 342 may be disposed between the pair of bearing portions 320, 1320 to adjust the distance between the pair of bearing portions 320, 1320 disposed adjacent to each other. For example, the second distance-adjusting member 342 may be disposed between the pair of inner races 321, 1321 to adjust the distance between the pair of inner races 321, 1321 disposed adjacent to each other.

The second distance-adjusting member 342 may have an annular or cylindrical shape through which the shaft 200 passes. The diameter of the second distance-adjusting member 342 may correspond to that of each of the inner races 321, 1321 of the bearing portions 320, 1320. Here, “correspond” may mean that the inner diameter of the second distance-adjusting member 342 is equal to the inner diameter of each of the inner races 321, 1321, and the outer diameter of the second distance-adjusting member 342 is less than or equal to the outer diameter of each of the inner races 321, 1321. Accordingly, as the inner races 321, 1321 rotate, the second distance-adjusting member 342 may rotate together with the inner races 321, 1321 without interference from the outer races 322, 1322.

In this case, the second distance-adjusting member 342 may have a predetermined length in the axis C direction (e.g., the X-axis direction). Opposite sides of the second distance-adjusting member 342 in the length direction (e.g., the X-axis direction) may respectively contact the pair of inner races 321, 1321. The length of the second distance-adjusting member 342 may function as a rated distance between the pair of inner races 321, 1321.

The third distance-adjusting member 343 may be disposed between the first bearing 320 and the roller 100 to adjust the distance between the bearing portion 320, 1320 and the roller 100. For example, the third distance-adjusting member 343 may be disposed between the inner race 321 of the first bearing 320 and the roller 100 to adjust the distance between the inner race 321 and the roller 100.

The third distance-adjusting member 343 may have an annular or cylindrical shape through which the shaft 200 passes. In this case, the diameter of the third distance-adjusting member 343 may correspond to the inner race 321 of the first bearing 320.

Meanwhile, the roller 100 may have an outer diameter greater than that of the shaft 200, and a step may be provided between the roller 100 and the shaft 200. The diameter of the third distance-adjusting member 343 may be smaller than the outer diameter of the roller 100. Accordingly, the third distance-adjusting member 343 may be configured to be caught by the step, and thus movement of the third distance-adjusting member 343 toward the roller 100 side (e.g., the X-axis direction) may be restricted.

The third distance-adjusting member 343 may have a predetermined length in the axis C direction (e.g., the X-axis direction). The opposite sides of the third distance-adjusting member 343 in the length direction (e.g., the X-axis direction) may respectively contact the inner race 321 of the first bearing 320 and the step. For example, one side of the third distance-adjusting member 343 may be fixed to the inner race 321 of the first bearing portion 320 or the step. When the third distance-adjusting member 343 is fixed to the inner race 321 of the first bearing 320, the third distance-adjusting member 343 may move together with the inner race 321. The length of the third distance-adjusting member 343 may function as a rated distance between the inner race 321 of the first bearing 320 and the roller 100.

Meanwhile, the distance-adjusting unit 340 may be formed of ring-shaped or cylindrical members, but the shape or structure of the distance-adjusting unit 340 is not particularly limited as long as the distance between two components can be set.

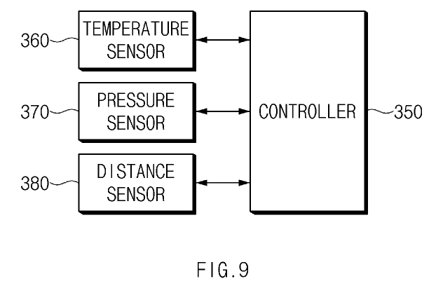

FIG. 9 is a block diagram illustrating a control configuration of a roller assembly according to the present disclosure.

Referring to FIG. 9, the roller assembly 10 according to the present disclosure may include a controller 350, a temperature sensor 360, a pressure sensor 370, and a distance sensor 380 to appropriately adjust a clearance value in the axis C direction between the inner race 321, 1321 and the outer race 322, 1322 of the bearing portion 320, 1320.

The controller 350 may control driving of the piston unit 330. For example, the controller 350 may control operation of the piston unit 330 such that the piston unit 330 reciprocates along the axis C direction of the shaft 200.

At least one servo valve (not illustrated) configured to provide driving force may be connected to the first piston 331 and/or the second piston 332. Accordingly, the first piston 331 and/or the second piston 332 may move in the axis C direction of the shaft 200 by the driving force provided by the servo valve.

According to an embodiment, the first piston 331 and the second piston 332 may move in the same direction.

For example, when the first piston 331 moves toward one side in the axis C direction, which is a direction in which the first piston 331 pushes the outer race 322 of the bearing portion 320, the second piston 332 may move toward the one side in the axis C direction while supporting the outer race 1322 on the opposite side of the first piston 331. In this case, the first piston 331 may be extended as a whole, and the second piston 332 may be shortened as a whole.

As another example, when the second piston 332 moves toward the other side in the axis C direction, which is a direction in which the second piston 332 pushes the outer race 1322 of the bearing portion 1320, the second piston 332 may move toward the other side in the axis C direction while supporting the outer race 1322 on the opposite side of the first piston 331. For example, when the second piston 332 is extended as a whole, the first piston 331 may be shortened as a whole.

The temperature sensor 360 may be disposed on the shaft 200 and/or the roller 100, and may measure a temperature of the shaft 200 and/or the roller 100.

The controller 350 may determine whether a thermal expansion (TE) of the shaft 200 and/or the roller 100 has been generated based on the temperature measured by the temperature sensor 360.

For example, when the temperature measured by the temperature sensor 360 is equal to or higher than a predetermined temperature, the controller 350 may determine that a thermal expansion (TE) of the shaft 200 and/or the roller 100 has been generated, and drive the first piston 331. In this case, the predetermined temperature may be the temperature of the shaft 200 and/or the roller 100 when the thermal expansion (TE) of the shaft 200 and/or the roller 100 is completed. In addition, the exact temperature value of the predetermined temperature may be experimentally determined depending on, for example, the length, the material, and the thickness of the shaft 200 and/or the roller 100.

When a thermal expansion (TE) has been generated, the controller 350 may determine that the inner race 321, 1321 of the bearing portion 320, 1320 has moved in a direction in which the inner races 321 and 1321 deviate from the inner portions of the outer races 322 and 1322, and thus a clearance in the axis C direction has been generated between the inner race 321, 1321 and the outer race 322, 1322. Accordingly, the controller 350 may drive the first piston 331 to push the outer race 322 of the first bearing 320 so as to eliminate the clearance in the axis C direction.

As another example, the temperature sensor 360 may include at least one temperature sensor, and may measure temperatures of different regions of the shaft 200. In this case, when a plurality of temperature values measured by the temperature sensor 360 are within a predetermined temperature range, the controller 350 may determine that the inner race 321, 1321 of the bearing portion 320, 1320 has moved in a direction in which the inner race 321, 1321 deviates from inner portion 322c, 1322c of the outer race 322, 1322, and thus a clearance in the axis C direction has been generated between the inner race 321, 1321 and the outer race 322, 1322.

In this case, the predetermined temperature range may be within an approximate range of the temperature of the shaft 200 and/or the roller 100 when the thermal expansion (TE) of the shaft 200 and/or the roller 100 has been completed. For example, when a plurality of temperatures measured in the different regions converge within the predetermined temperature range, this means that the overall temperature of the shaft 200 and/or the roller 100 has increased to a similar temperature, and thus may mean that the thermal expansion (TE) due to heating of the shaft 200 and/or the roller 100 has been completed. In this case, an exact temperature range value of the predetermined temperature range may be experimentally determined depending on, for example, the length, the material, and the thickness of the shaft 200 and/or the roller 100.

When a thermal expansion (TE) has been generated, the controller 350 may determine that the inner race 321, 1321 of the bearing portion 320, 1320 has moved in a direction in which the inner race 321, 1321 deviates from the inner portion of the outer race 322, 1322, and thus a clearance in the axis C direction has been generated between the inner race 321, 1321 and the outer race 322, 1322. Accordingly, the controller 350 may drive the first piston 331 to push the outer race 322 of the first bearing 320 so as to eliminate the clearance in the axis C direction.

The pressure sensor 370 may measure pressure applied to the first piston 331. Here, the pressure sensor 370 may be disposed at an end of the first piston 331 facing the outer race 322 of the first bearing 320, or may be disposed between the first piston member 331a and the first adapter 331b.

In this case, the controller 350 may determine whether a clearance in the axis C direction between the inner race 321, 1321 and the outer race 322, 1322 of the bearing portion 320, 1320 has been eliminated by the first piston 331 based on the pressure measured by the pressure sensor 370. For example, when the pressure measured by the pressure sensor 370 is equal to or higher than a predetermined pressure, or when a rapid change in pressure is detected by the pressure sensor 370, the controller 350 may determine that the clearance in the axis C direction between the inner race 321, 1321 and the outer race 322, 1322 of the bearing portion 320, 1320 has been eliminated, and may drive the second piston 332. For example, when the clearance in the axis C direction has been eliminated, the controller 350 may drive the second piston 332 to push the outer race 1322 of the second bearing 1320 such that an appropriate clearance in the axis C direction is generated again between the inner race 321, 1321 and the outer race 322, 1322 of the bearing portion 320, 1320. In this case, the direction in which the second piston 332 pushes the outer race 1322 may be opposite to the direction in which the first piston 331 pushes the outer race 322. In addition, in a state in which the clearance in the axis C direction between the inner race 321, 1321 and the outer race 322, 1322 of the bearing portion 320, 1320 has been eliminated, the rotating member 323, 1323 may be in contact with the inner race 321, 1321 and the outer race 322, and 1322 of the bearing portion 320, 1320, or the opposite ends of the inner race 321, 1321 in the axis C direction may be disposed in the inner portion 322c, 1322c of the outer race 322, 1322.

The distance sensor 380 may be disposed on the first piston 331 and/or the second piston 332. The distance sensor 380 disposed on the first piston 331 may be a first distance sensor 381, and the distance sensor 380 disposed on the second piston 332 may be a second distance sensor 382.

When the second piston 332 pushes and moves the outer race 1322 of the second bearing 1320 in the state in which the clearance in the axis C direction between the inner race 321, 1321 and the outer race 1322 of the second bearing 1320 has been eliminated, the distance sensor 380 may measure a distance by which the outer race 1322 of the second bearing 1320 has moved. In this case, the first distance sensor 381 may measure the distance by which the first piston 331 has moved backward, and the second distance sensor 382 may measure the distance by which the second piston 332 has moved forward.

The controller 350 may move the second piston 332 to push the outer race 1322 of the second bearing 1320 until the distance by which the outer race 1322 of the second bearing 1320 has moved reaches a predetermined distance. At the same time, the controller 350 may move the first piston 331 in the same direction as the moving direction of the second piston 332 to support the outer race 322 of the first bearing 320. Accordingly, the clearance in the axis C direction between the inner race 321, 1321 and the outer race 322, 1322 may be set to an appropriate state.

Hereinafter, a process in which the bearing unit 300 according to the present disclosure adjusts a clearance value to an appropriate state will be described with reference to FIGS. 5 to 8.

The piston unit 330 according to the present disclosure may set a clearance in the axis C direction between the inner race 321, 1321 and the outer race 322, 1322 of the bearing portion 320, 1320 to an appropriate state for smooth operation of the bearing unit 300. For example, the clearance in the axis C direction between the inner race 321, 1321 and the outer race 322, 1322 of the bearing portion 320, 1320, which is generated due to the thermal expansion (TE) of the shaft 200 and/or the roller 100, may cause a problem in normal operation of the bearing unit 300. However, when the bearing unit 300 operates in a state in which the clearance in the axis C direction has been completely eliminated, for example, scratching or damage between the components of the bearing unit 300 may occur. Accordingly, the clearance in the axis C direction between the inner race 321, 1321 and the outer race 322, 1322 of the bearing portion 320, 1320, which is finally set by the piston unit 330, needs to be maintained in an appropriate state.

For example, FIG. 5 illustrates a state in which there is no clearance in the axis C direction between the inner race 321, 1321 and the outer race 322, 1322 of the bearing portion 320, 1320. The state in which there is no clearance in the axis C direction may be a state in which the first piston 331 and the second piston 332 do not operate, or may be a state in which a resultant force of a force by which the first piston 331 pushes the outer race 322 of the first bearing 320 and a force by which the second piston 332 pushes the outer race 1322 of the second bearing 1320 is zero.

FIG. 6 illustrates a state in which the shaft 200 and/or the roller 100 of FIG. 5 undergo a thermal expansion (TE) and the inner race 321, 1321 of each of the bearing portions 320, 1320 has moved by a first distance D1 in the axis C direction (e.g., the X-axis direction) (hereinafter, referred to as a “first state”). In this case, since an excessive clearance in the axis C direction is generated between the inner race 321, 1321 and the outer race 322, 1322, it is necessary to eliminate the excessive clearance in the axis C direction.

Meanwhile, when the temperature of the shaft 200 and/or the roller 100 measured by the temperature sensor 360 is equal to or higher than a predetermined temperature, or when temperatures measured by a plurality of temperature sensors 360 are within a predetermined temperature range, the controller 350 may determine that the bearing unit 300 is in the first state.

FIG. 7 illustrates a state in which the first piston 331 has pushed and moved (M1) the outer race 322 of the first bearing 320 by a first distance D1 and an excessive clearance in the axis C direction has been moved (hereinafter, referred to as a “second state”). In this case, the first distance D1 may refer to a difference between a length L2 of the first piston 331 in the axis C direction in the second state and a length L1 of the first piston 331 in the axis C direction in the first state.

Meanwhile, when a pressure applied to the first piston 331 measured by the pressure sensor 370 is equal to or higher than a predetermined pressure, or when a rapid pressure change is detected by the pressure sensor 370, the controller 350 may determine that the bearing unit 300 is in the second state.

In addition, since the first distance-adjusting member 341 is disposed between the outer race 322 of the first bearing 320 and the outer race 1322 of the second bearing 1320, when the first piston 331 applies a first external force to the outer race 322 of the first bearing 320, the first distance-adjusting member 341 may transmit the first external force to the outer race 1322 of the second bearing 1320. In this case, the first external force may be greater than a frictional force acting between the outer race 322 of the first bearing 320 and the housing unit 311 and a frictional force acting between the outer race 1322 of the second bearing 1320 and the housing unit 311.

FIG. 8 illustrates a state in which the second piston 332 has pushed and moved (M2) the outer race 1322 of the second bearing 1320 by a second distance D2 to intentionally generate a clearance in the axis C direction between the inner race 321, 1321 and the outer race 322, 1322 of the bearing portion 320, 1320 (hereinafter, referred to as a “third state”). In this case, the second distance D2 may refer to a difference between the length L2 of the first piston 331 in the second state and the length L3 of the first piston 331 in the third state.

In this case, the second distance D2 may be smaller than the first distance D1. Since the clearance in the axis C direction between the inner race 321, 1321 and the outer race 322, 1322 of the bearing portions 320, 1320, which is generated due to the thermal expansion (TE) of the shaft 200 and/or the roller 100, needs to be set to an appropriate state, the clearance in the axis C direction between the inner race 321, 1321 and the outer race 322, 1322, which is finally set by the piston unit 330, may not be zero but may be set to be smaller than the clearance in the axis C direction between the inner race 321, 1321 and the outer race 322, 1322, which is generated due to the thermal expansion (TE) of the shaft 200 and/or the roller 100. Accordingly, when the second piston 332 pushes and moves the outer race 1322 of the second bearing 1320 by the second distance D2 as in the third state, the clearance in the axis C direction between the inner race 321, 1321 and the outer race 322, 1322 may be set to an appropriate state.

Meanwhile, the controller 350 may move the second piston 332 to push the outer race 1322 of the second bearing 1320 until the second distance D2 measured by the distance sensor 380 reaches a predetermined distance, and may move the first piston 331 to support the outer race 322 of the first bearing 320 from the opposite side. In this case, the first piston 331 and the second piston 332 may move in the same direction. In addition, the moving speed of the second piston 332 and the moving speed of the first piston 331 may correspond to each other.

In addition, since the first distance-adjusting member 341 is disposed between the outer race 322 of the first bearing 320 and the outer race 1322 of the second bearing 1320, when the second piston 332 applies a second external force to the outer race 1322 of the second bearing 1320, the first distance-adjusting member 341 may transmit the second external force to the outer race 322 of the first bearing 320. In this case, the second external force may be greater than a frictional force acting between the outer race 1322 of the second bearing 1320 and the housing unit 311 and a frictional force acting between the outer race 322 of the first bearing 320 and the housing unit 311.

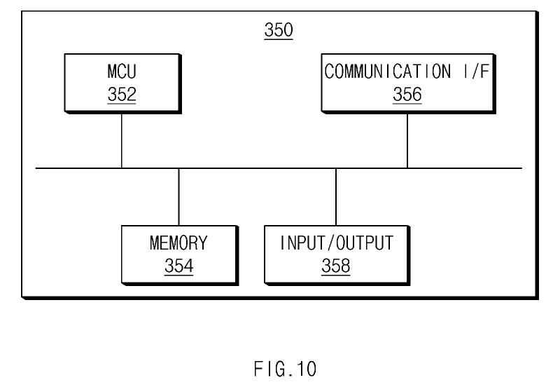

FIG. 10 is a block diagram illustrating a hardware configuration implementing a controller 350 according to the present disclosure.

The controller 350 according to an embodiment disclosed herein may include an MCU 352, a memory 354, a communication I/F 356, and an input/output I/F 358. The MCU 352 refers to a micro controller unit and is a processor configured to execute various programs stored in the memory 354, to process various data used for such programs, and to perform functions of the controller 350.

The memory 354 may store various operation data of programs related to operation of a lithium secondary battery system for operation of the controller 350. A plurality of memories 354 may be provided, as necessary. The memory 354 may be a volatile memory or a nonvolatile memory. As the volatile memory, the memory 354 may include, for example, RAM, DRAM, and SRAM. As the nonvolatile memory, the memory 354 may include, for example, ROM, PROM, EAROM, EPROM, EEPROM, and flash memory. Examples of the memory 354 listed above are merely illustrative and are not limited thereto.

The communication I/F 356 may be configured to transmit and receive various data to and from a server, and may include various devices capable of supporting wired or wireless communication. For example, through the communication I/F 356, programs for operation of the controller 350 and various data may be transmitted and received, via wired or wireless communication, to and from an external server separately provided. The input/output I/F 358 may provide an interface that enables data transmission and reception by connecting an input device (not illustrated) such as a keyboard, a mouse, or a touch panel and an output device such as a display (not illustrated) to the MCU 352.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith.

What is claimed is:

1. A bearing unit comprising:
a bearing portion configured to rotatably support a shaft; and
a piston unit configured to apply an external force to the bearing portion in an axial direction of the shaft,
wherein the bearing portion includes:
an inner race coupled to the shaft and configured to rotate together with the shaft, and
an outer race surrounding the inner race such that the inner race is disposed therein,
the piston unit includes:
a first piston disposed on one side of the bearing portion and configured to push and move the outer race of the bearing portion so as to eliminate an axial clearance, when the inner race of the bearing portion moves in a direction in which the inner race deviates from an inner portion of the outer race of the bearing portion and the axial clearance is generated between the inner race and the outer race of the bearing portion, and
a second piston disposed on the other side of the bearing portion and configured to push and move the outer race of the bearing portion such that, when the axial clearance is eliminated by the first piston, the inner race deviates from the inner portion of the outer race of the bearing portion,
wherein the direction in which the first piston pushes the outer race of the bearing portion and the direction in which the second piston pushes the outer race of the bearing portion are opposite to each other.

2. The bearing unit according to claim 1, wherein when the shaft undergoes a thermal expansion, the inner race of the bearing portion moves in the axial direction of the shaft.

3. The bearing unit according to claim 1, further comprising:
a controller configured to control driving of the piston unit,
wherein the bearing portion includes a rolling member disposed between the inner race and the outer race of the bearing portion and configured to rotatably support the inner race of the bearing portion relative to the outer race of the bearing portion, and
when the inner race of the bearing portion and the outer race of the bearing portion contact the rolling member, the controller determines that the axial clearance has been eliminated.

4. The bearing unit according to claim 1, further comprising:
a controller configured to control driving of the piston unit; and
a temperature sensor configured to measure a temperature of the shaft,
wherein, when the temperature of the shaft is equal to or higher than a predetermined temperature, the controller determines that the inner race has moved in a direction in which the inner race deviates from the inner portion the outer race of the bearing portion and drives the first piston to push the outer race of the bearing portion.

5. The bearing unit according to claim 1, further comprising:
a controller configured to control driving of the piston unit; and
a temperature sensor configured to measure temperatures of different regions of the shaft,
wherein, when a plurality of temperature values measured by the temperature sensor are within a predetermined temperature range, the controller determines that the inner race of the bearing portion has moved in a direction in which the inner race deviates from the inner portion of the outer race of the bearing portion, and drives the first piston to push the outer race of the bearing portion.

6. The bearing unit according to claim 1, further comprising:
a controller configured to control driving of the piston unit; and
a pressure sensor disposed on the first piston and configured to measure a pressure applied to the first piston,
wherein, when the pressure applied to the first piston is equal to or higher than a predetermined pressure, the controller determines that an axial clearance between the inner race of the bearing portion and the outer race of the bearing portion has been eliminated, and drives the second piston to push the outer race of the bearing portion.

7. The bearing unit according to claim 1, wherein
the first piston moves the outer race of the bearing portion by a first distance,
the second piston moves the outer race of the bearing portion by a second distance, and
the second distance is smaller than the first distance.

8. The bearing unit according to claim 7, further comprising:
a controller configured to control driving of the piston unit; and
a distance sensor configured to detect the second distance by which the outer race has moved,
wherein the controller drives the second piston to push the outer race of the bearing until the second distance reaches a predetermined distance.

9. The bearing unit according to claim 1, further comprising:
a bearing housing configured to accommodate the bearing portion therein,
wherein an outer circumferential surface of the outer race of the bearing portion is interference-fitted into an inner circumferential surface of the bearing housing.

10. The bearing unit according to claim 9, wherein the external force applied to the bearing portion by the piston unit is greater than a frictional force between the outer race of the bearing portion and the bearing housing.

11. The bearing unit according to claim 9, wherein the piston unit moves while being guided by the bearing housing.

12. The bearing unit according to claim 1, wherein at least one of the first piston and the second piston includes:
a piston member configured to reciprocate along an axial direction of the shaft, and
an adapter disposed at an end portion of the piston member facing the outer race of the bearing portion and configured to move together with the piston member,
wherein the adapter applies an external force to the outer race of the bearing portion, when the piston member moves in a direction toward the outer race of the bearing portion.

13. The bearing unit according to claim 12, wherein the adapter includes:
a first adapter portion configured to contact the outer race of the bearing portion and support the outer race of the bearing portion, and
a second adapter portion extending from the first adapter portion toward the shaft and disposed to be spaced apart from the inner race of the bearing portion.

14. The bearing unit according to claim 13, wherein the second adapter portion forms a step with the first adapter portion.

15. The bearing unit according to claim 13, wherein the distance between the first adapter portion and the shaft is greater than the distance between the second adapter portion and the shaft.

16. The bearing unit according to claim 1, wherein the bearing portion is a tapered roller bearing.

17. The bearing unit according to claim 1, wherein the bearing portion includes:
a first bearing and a second bearing disposed adjacent to each other, and
the bearing unit further includes a distance-adjusting unit disposed between the first bearing and the second bearing and configured to adjust the distance between the first bearing and the second bearing.

18. A roller assembly for press-molding powder into a sheet-type electrode or for conveying a sheet-type electrode, the roller assembly comprising:
a roller;
a shaft extending from the roller; and
a bearing unit including a bearing portion configured to rotatably support the shaft and a piston unit configured to apply an external force to the bearing portion in an axial direction of the shaft,
wherein the bearing portion includes:
an inner race coupled to the shaft and configured to rotate together with the shaft, and
an outer race surrounding the inner race such that the inner race is disposed in an inner portion of the outer race,
the piston unit includes:
a first piston disposed on one side of the bearing portion and a second piston disposed on the other side of the bearing portion and configured to push and move the outer race of the bearing portion so as to eliminate the axial clearance, when the inner race of the bearing portion moves in a direction in which the inner race deviates from an inner portion of the outer race of the bearing portion and an axial clearance is generated between the inner race and the outer race of the bearing portion, and
a second piston disposed on the other side of the bearing portion and configured to push and move the outer race of the bearing portion such that, when the axial clearance is eliminated by the first piston, the inner race deviates from the inner portion of the outer race of the bearing portion,
wherein the direction in which the first piston pushes the outer race of the bearing portion and the direction in which the second piston pushes the outer race of the bearing portion are opposite to each other.
